(19) United States
(12) Patent Application Publication
(10) Pub. No.: US 2022/0234180 A1
(43) Pub. Date: Jul. 28, 2022

(54) NAIL GUN

(71) Applicant: BASSO INDUSTRY CORP., Taichung (TW)

(72) Inventors: An-Gi LIU, Taichung (TW); Yuan-Chi CHIANG, Taichung (TW)

(73) Assignee: BASSO INDUSTRY CORP., Taichung (TW)

(21) Appl. No.: 17/581,383

(22) Filed: Jan. 21, 2022

(30) Foreign Application Priority Data
Jan. 26, 2021 (TW) 110102819

(51) Int. Cl. B25C 1/00; B25C 1/04

(52) U.S. Cl. CPC B25C 1/008; B25C 1/043; B25C 1/001

(57) ABSTRACT

A nail gun includes a frame unit, a power unit that is configured to drive a nail-striking action during a driving process, a switch unit that includes a first switch and a second switch configured to initiate the driving process when both actuated, a safety unit that is operable to convert between a non-triggerable state and a triggerable state for actuating the first switch, and that includes a moving assembly that is movable relative to the frame unit along a moving path, and a trigger unit that includes a trigger pivotable between a sequential firing position and a continuous firing position, and an operating member pivotable between the trigger and the second switch.

### CROSS-REFERENCE TO RELATED APPLICATION

This application claims priority of Taiwanese Patent Application No. 110102819, filed on Jan. 26, 2021.

### FIELD

The disclosure relates to a nail gun, and more particularly to a nail gun that is capable of switching between different firing modes.

### BACKGROUND

In order to prevent safety hazards and to comply with certain industrial regulations, a conventional nail gun generally includes a safety unit and a trigger unit that are configured as two switches that cooperate with each other to determine whether to initiate a nail-striking action so as to ensure the safety of a user. However, the safety mechanism of such conventional nail gun can only operate under a sequential firing mode or a continuous firing mode, not both.

### SUMMARY

Therefore, the object of the disclosure is to provide a nail gun that is capable of switching between different firing modes.

According to the disclosure, a nail gun includes a frame unit, a power unit, a switch unit, a safety unit and a trigger unit.

The power unit is mounted to the frame unit, and is configured to drive a nail-striking action during a driving process. The switch unit is mounted to the frame unit, and includes a first switch and a second switch configured to initiate the driving process when both actuated. The safety unit is operable to convert between a non-triggerable state where the safety unit is distal from the first switch, and a triggerable state where the safety unit actuates the first switch. The safety unit includes a moving assembly that is movable relative to the frame unit along a moving path.

The trigger unit includes a trigger and an operating member. The trigger is pivotally mounted to the frame unit, and is pivotable between a sequential firing position and a continuous firing position. The operating member is pivotable between the trigger and the second switch.

When the safety unit is in the triggerable state, and when the trigger is pivoted from the sequential firing position toward the second switch, the operating member is moved by the trigger to contact the safety unit, to thereby actuate the second switch to initiate the driving process, after which the operating member separates from the moving path of the moving assembly of the safety unit so as to prevent initiation of subsequent driving process.

When the trigger unit is pivoted from the continuous firing position toward the second switch, and when the safety unit is converted from the non-triggerable state into the triggerable state, the moving assembly of the safety unit comes into contact with the operating member to initiate the driving process.

### BRIEF DESCRIPTION OF THE DRAWINGS

Other features and advantages of the disclosure will become apparent in the following detailed description of the embodiment with reference to the accompanying drawings, of which:

FIG. 1 is a side view of an embodiment of a nail gun according to the disclosure;

FIG. 2 is a fragmentary and partially exploded perspective view of the embodiment;

FIG. 3 is a fragmentary sectional view taken along line III-III in FIG. 1;

FIG. 4 is a fragmentary sectional view taken along line IV-IV in FIG. 3, illustrating a safety unit of the embodiment in a non-triggerable state, and a trigger of the embodiment at a sequential firing position;

FIG. 5 is a fragmentary sectional view similar to FIG. 4, but illustrating the trigger being pivoted toward a second switch of the embodiment;

FIG. 6 is a fragmentary sectional view similar to FIG. 5, but illustrating the safety unit in a triggerable state;

FIG. 7 is another fragmentary sectional view similar to FIG. 4, but illustrating the safety unit in the triggerable state where a first switch of the embodiment is actuated;

FIG. 8 is a fragmentary sectional view similar to FIG. 7, but illustrating the trigger being pivoted toward the second switch and an operating member of the trigger unit actuating the second switch;

FIG. 9 is a fragmentary sectional view similar to FIG. 3, but illustrating the trigger being pivoted to a continuous firing position via a switching member; and

FIG. 10 is a fragmentary sectional view taken along line X-X in FIG. 9, illustrating the safety unit in the triggerable state.

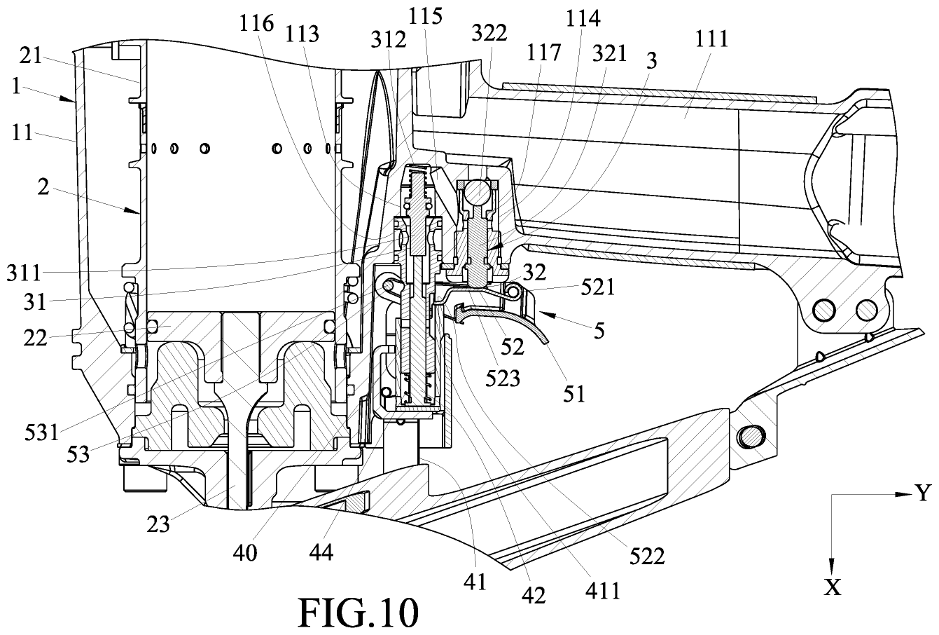

### DETAILED DESCRIPTION

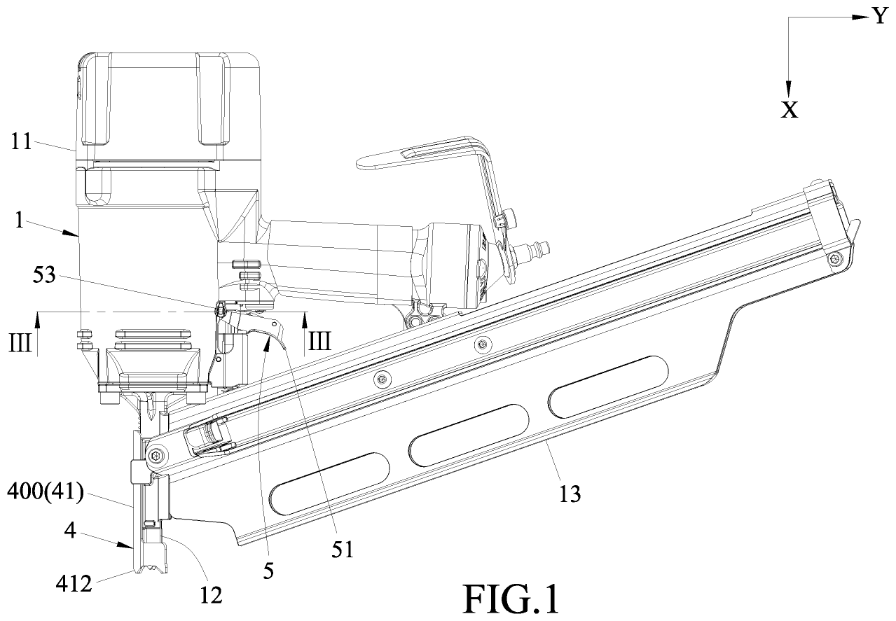

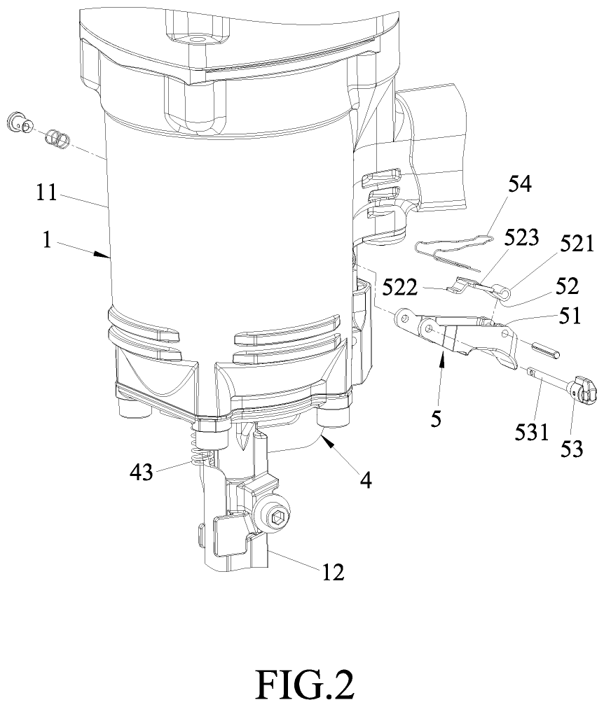

Referring to FIGS. 1 and 2, an embodiment of a nail gun according to the disclosure includes a frame unit 1, a power unit 2, a switch unit 3, a safety unit 4 and a trigger unit 5.

Referring to FIGS. 2, 3 and 4, the frame unit 1 includes a main body 11, a muzzle 12 that is connected to the main body 11, and a magazine 13 that is connected to the muzzle 12, and that is adapted for loading a plurality of nails (not shown) and for sending the nails to the muzzle 12 in a consecutive manner.

The main body 11 has an inlet passage 111 adapted for guiding a pressurized gas into the power unit 2, a switch passage 112, a first valve room 113 in fluid communication with the switch passage 112, a second valve room 114 in fluid communication with the inlet passage 111, and a connecting passage 115 disposed between and in fluid communication with the first valve room 113 and the second valve room 114. In the present embodiment, the first valve room 113 and the second valve room 114 are arranged along a moving direction (Y). The first valve room 113 has a first neck section 116, and the second valve room 114 has a second neck section 117.

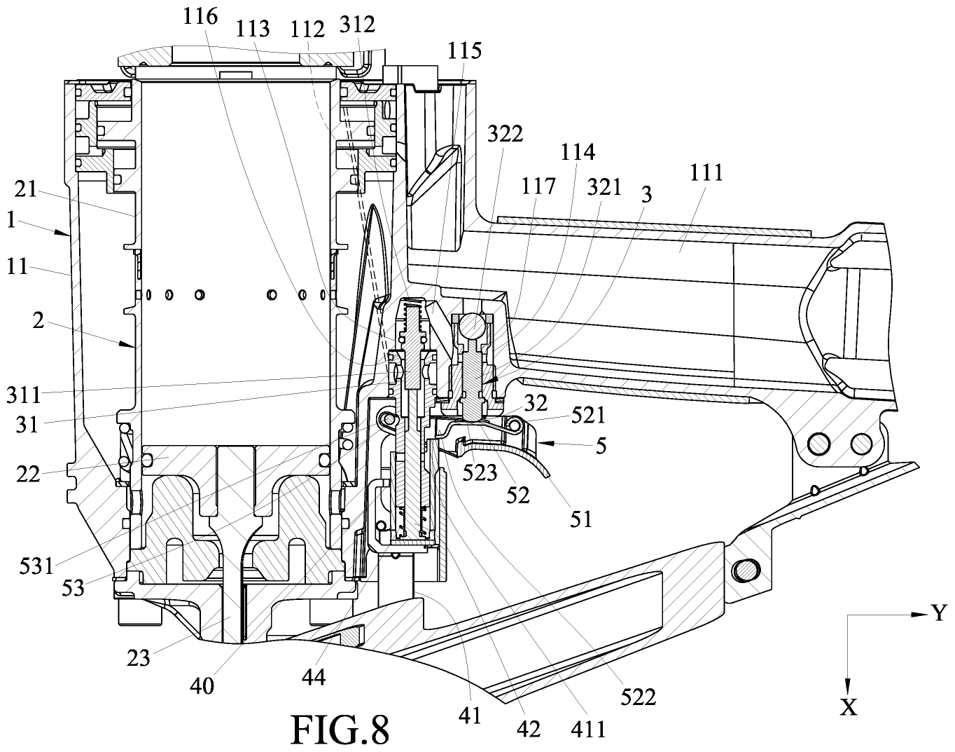

The power unit 2 is mounted to the main body 11 of the frame unit 1, is configured to drive a nail-striking action during a driving process, and includes a cylinder 21, a piston 22 (see FIG. 8), and a striking member 23. The cylinder 21 is adapted for receiving the pressurized gas guided by the inlet passage 111 of the frame unit 1. The piston 22 is movably disposed in the cylinder 21 and is adapted to be driven by the pressurized gas to move. The striking member 23 is co-movably connected to the piston 22 and is configured to perform the nail-striking action.

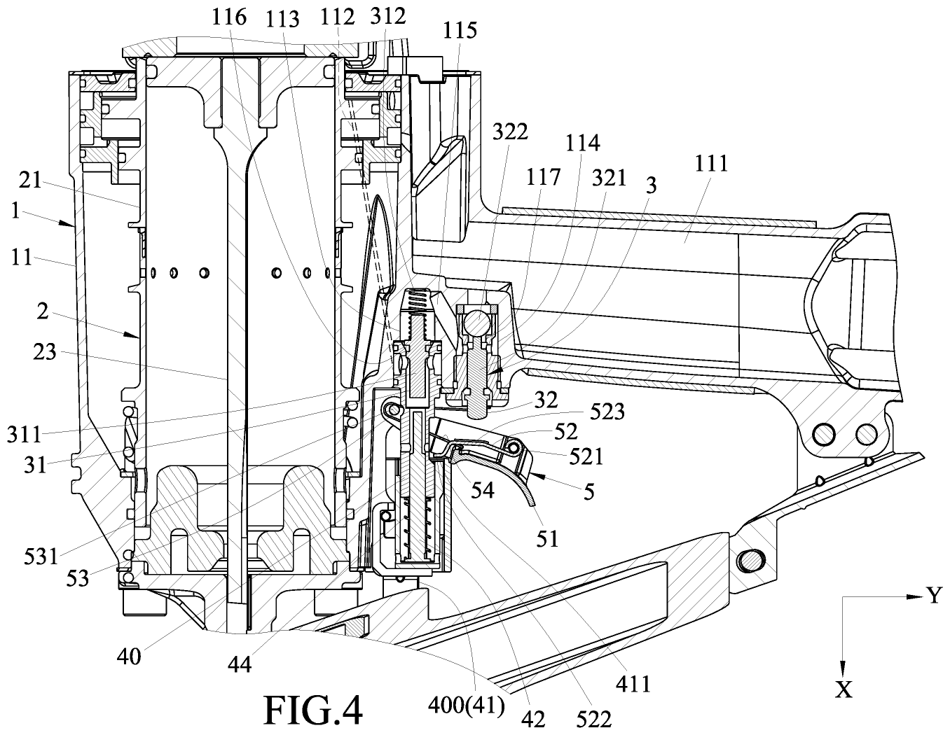

Specifically, in the present embodiment, the cylinder 21 is a movable cylinder, which is adapted to be driven by gas guided by the switch passage 112 of the frame unit 1 to move relative to the main body 11 between a closed position (see FIG. 4) and an open position (see FIG. 8). When the cylinder 21 is at the closed position, fluid communication between the cylinder 21 and the inlet passage 111 of the main body is blocked, such that the pressurized gas is prevented from entering the cylinder 21 through the inlet passage 111. When the cylinder 21 is at the open position, a gap is formed between the cylinder 21 and the main body 11 of the frame unit 1, such that the cylinder 21 and the inlet passage 111 are in fluid communication, and the pressurized gas is thus allowed to enter the cylinder 21 through the inlet passage 111. Since the working principle of the aforementioned movable cylinder is well known in the art and not the feature of the present embodiment, no further description will be given hereinafter.

It should be noted that, the power unit 2 of the nail gun is not limited to being powered by means of pressurized gas, but may also be powered by fuel combustion or electric power, the relevant techniques of which are also well known in the art and thus will not be further described hereinafter.

The switch unit 3 is mounted to main body 11 of the frame unit 1, is adapted to control the pressurized gas to be input into the cylinder 21, and includes a first switch 31 and a second switch 32 that are arranged along the moving direction (Y), and that are configured to initiate the driving process when both being actuated.

The first switch 31 is installed in the first valve room 113, and is configured to control the fluid communication between the first valve room 113 and the switch passage 112. The second switch 32 is installed in the second valve room 114, and is configured to control the fluid communication between the second valve room 114 and the connecting passage 115.

Specifically, the first switch 31 has a first valve rod 311 that movably blocks the first neck section 116 of the first valve room 113, and a valve rod-biasing resilient member 312 that is disposed between the main body 11 and the first valve rod 311 for biasing the first valve rod 311 so as to openably block the fluid communication between the first valve room 113 and the switch passage 112. The second switch 32 has a second valve rod 321 and a valve member 322 that are movably disposed in the second valve room 114. In the present embodiment, the valve member 322 is ball-shaped, is adapted to be forced by the pressurized gas to block the second neck section 117 of the second valve room 114 so as to openably block the fluid communication between the second valve room 114 and the connecting passage 115, and is configured to be pushed by the second valve rod 321 to unblock the second neck section 117 of the second valve room 114.

Referring to FIGS. 1, 2 and 4, the safety unit 4 includes a moving assembly 400 that is movable relative to the frame unit 1 along a moving path, and is operable to convert between a non-triggerable state where the safety unit 4 is distal from the first switch 31, and a triggerable state where the safety unit 4 actuates the first switch 31.

Specifically, the safety unit 4 further includes a sleeve member 40, a safety member 41, an extending member 42, a safety member-biasing resilient member 43, and an extending member-biasing resilient member 44. The sleeve member 40 is connected to the frame unit 1, extends along a length direction (X), and has two open ends being opposite along the length direction (X). The first valve rod 311 of the first switch 31 and the extending member 42 extend into the open ends of the sleeve member 40, respectively. In the present embodiment, the length direction (X) is substantially perpendicular to the moving direction (Y).

The safety member 41 extends along the length direction (X), is movably mounted to the frame unit 1 between the main body 11 and the muzzle 12, and has an abutting end 411 proximate to the switch unit 3, and a workpiece-engaging end 412 opposite to the abutting end 411 and adapted to be pressed by a workpiece (not shown). The extending member 42 abuts against and is disposed between the safety member 41 and the first valve rod 311 of the first switch 31. When the safety unit 4 is in the triggerable state, the extending member 42 presses against the first valve rod 311 to open the fluid communication between the first valve room 113 and the switch passage 112. The extending member 42 cooperates with the safety member 41 to constitute the moving assembly 400.

The safety member-biasing resilient member 43 is disposed between the muzzle 12 of the frame unit 1 and the safety member 41 for biasing the workpiece-engaging end 412 of the safety member 41 away from the frame unit 1. The extending member-biasing resilient member 44 is disposed between the sleeve member 40 and the extending member 42 for biasing the extending member 42 away from the first valve rod 311 of the first switch 31.

The trigger unit 5 includes a trigger 51, an operating member 52, a switching member 53, and a trigger-biasing resilient member 54.

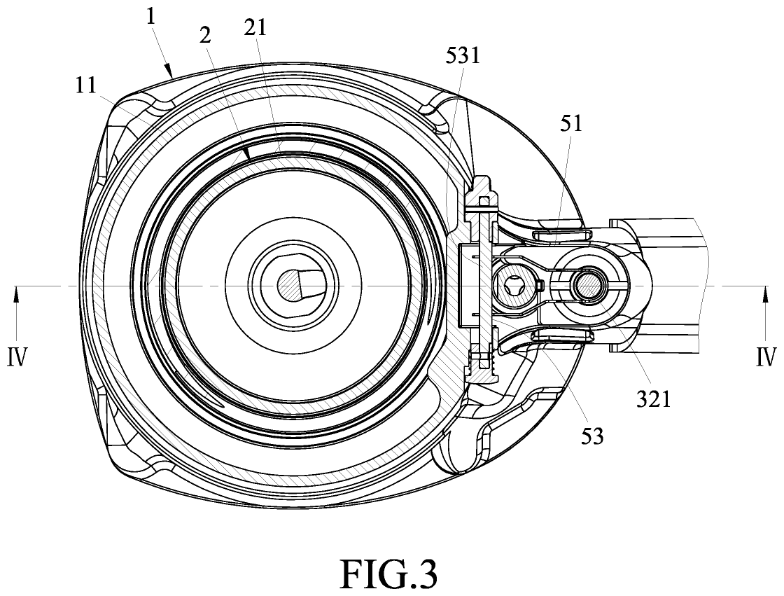

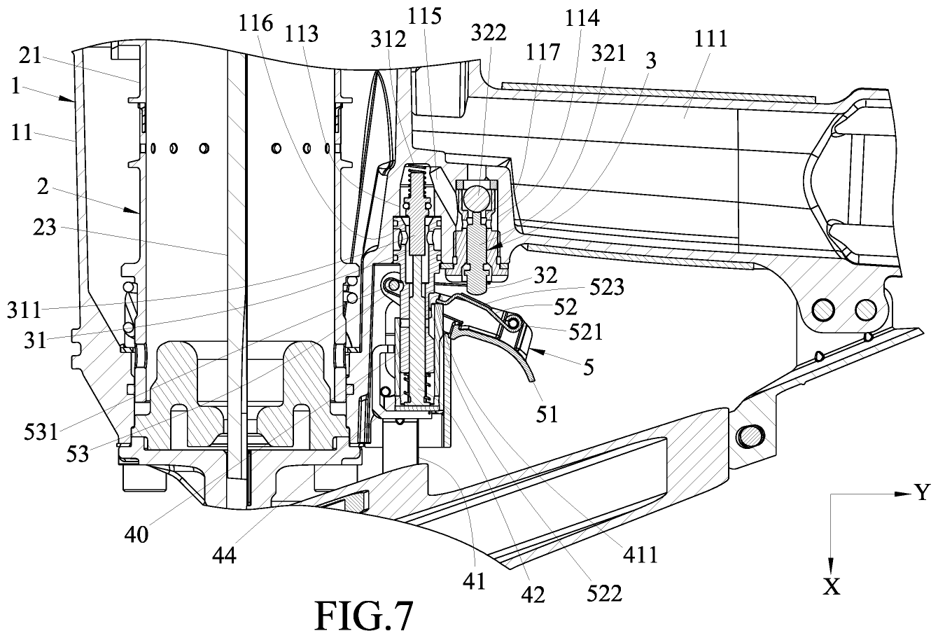

The trigger 51 is pivotally mounted to the frame unit 1, and is pivotable between a sequential firing position (see FIGS. 3 to 6) and a continuous firing position (see FIGS. 7 and 8).

The operating member 52 is movably disposed between the trigger 51 and the second switch 32, is contactable with the safety unit 4, and is configured to be driven by the trigger 51 to actuate the second switch 32. The operating member 52 has a pivot end 521 that is pivoted to the trigger 51, a distal end 522 that is opposite to the pivot end 521 and that extends removably into the moving path of the moving assembly of the safety unit 4, and a pressing portion 523 that is connected between the pivot end 521 and the distal end 522 and that is configured for pressing against and actuating the second switch 32. Specifically, the operating member 52 is configured to press against the second valve rod 321 of the second switch 32 so as to open the fluid communication between the second valve room 114 and the connecting passage 115.

The switching member 53 rotatably extends through the main body 11 of the frame unit 1, is disposed between the cylinder 21 and the first switch 31, and has an eccentric shaft 531 extending rotatably into the trigger 51. The switching member 53 is rotatable to move the eccentric shaft 531 toward the first switch 31 along a moving direction (Y) so as to pivot the trigger 51 to the sequential firing position, and is rotatable to move the eccentric shaft 531 away from the first switch 31 along the moving direction (Y) so as to pivot the trigger 51 to the continuous firing position.

The trigger-biasing resilient member 54 is disposed between the trigger 51 and the main body 11 of the frame unit 1 for biasing the trigger 51 away from the switch unit 3.

Referring to FIGS. 1 to 6, an operation of the nail gun of the present embodiment is described as follows.

Prior to the operation, as shown in FIG. 1, the trigger 51 is distal from the second switch 32, and the moving assembly 400 of the safety unit 4 (i.e., an assembly of the safety member 41 and the extending member 42) is biased by the safety member-biasing resilient member 43 and the extending member-biasing resilient member 44, such that the workpiece-abutting end 412 of the safety member 41 protrudes out of the muzzle 12.

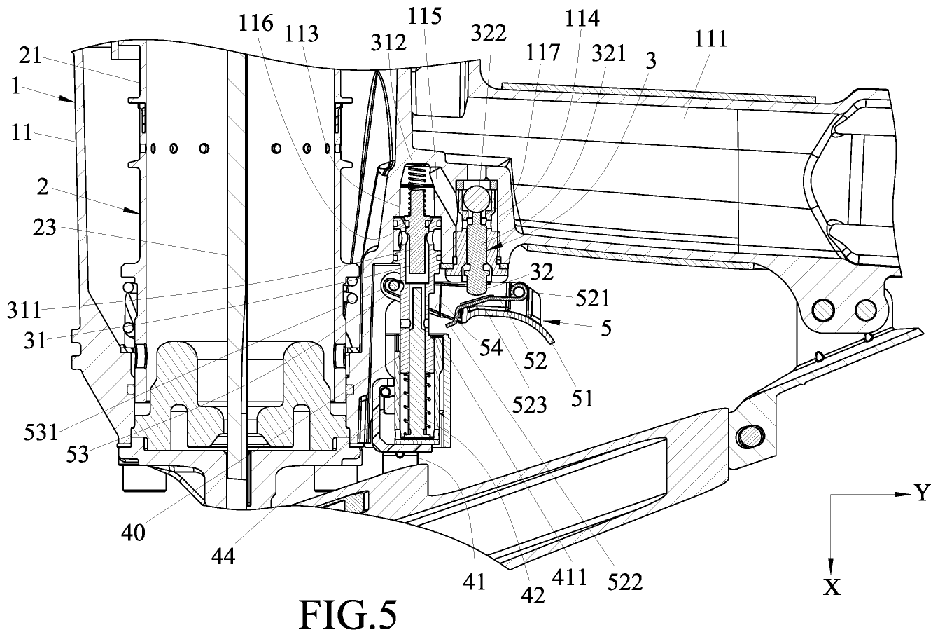

Referring to FIGS. 3 and 4, when the switching member 53 is rotated such that the eccentric shaft 531 is moved slightly toward the first switch 31 along the moving direction (Y) to pivot the trigger 51 to the sequential firing position, if the trigger 51 is first pressed to move the pivot end 521 of the operating member 52 toward the second switch 32 (see FIG. 5), the distal end 522 of the operating member separates from the moving path of the moving assembly 400 of the safety unit 4, such that the pressing portion 523 of the operating member 52 is prevented from actuating the second switch 32, which then prevents initiation of subsequent driving process.

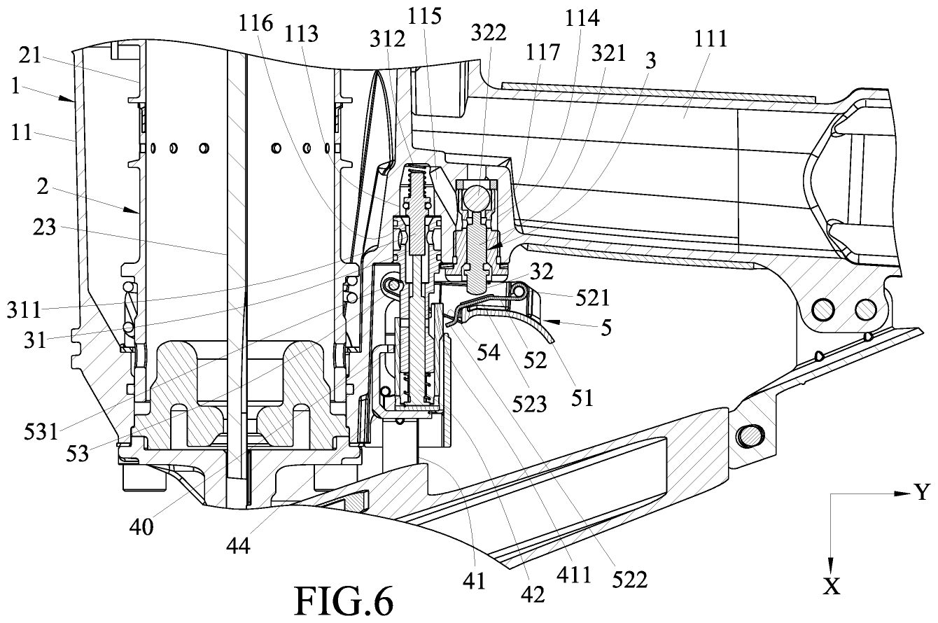

Referring further to FIG. 6, at this time, if the workpiece-engaging end 412 of the safety member 41 is pressed by the workpiece such that the extending member 42 moves toward and actuates the first switch 31, the second switch 32 will not be actuated by the operating member 52 since the distal end 522 of the operating member 52 is separated from the moving path of the moving assembly 400 and cannot be driven by movement of the extending member 42, and the subsequent driving process is still prevented from initiation.

Referring to FIGS. 4, 7 and 8, when the trigger 51 is at the sequential firing position, and when the workpiece-engaging end 412 of the safety member 41 is pressed by the workpiece first and moves the extending member 42 toward the first switch 31 (i.e., the safety unit is converted to the triggerable state), the extending member 42 pushes the first valve rod 311 of the first switch 31 along the length direction (X) to unblock the first neck section 116 of the first valve room 113 (i.e., allowing fluid communication between the first valve room 113 and the switch passage 112), and the distal end 522 of the operating member 52 is pushed by the abutting end 411 of the safety member 41 toward the second switch 32. Then, when the trigger is pivoted from the sequential firing position toward the second switch 32, the pressing portion 523 of the operating member 52 is moved by the trigger 51 to actuate the second switch 32 (i.e., pushing the second valve rod 321 along the length direction (X) to further push the valve member 322 away from the second neck section 117 of the second valve room 114), thus allowing fluid communication between the second valve room 114 and the connecting passage 115 to initiate the driving process.

After the initiation of the driving process, the pressurized gas enters the second valve room 114 via the inlet passage 111, and then travels through the connecting passage 115, the first valve room 113 and the switch passage 112 and into the cylinder 21. Next, the cylinder 21 is driven to move from the closed position to the open position such that the pressurized gas traveling from the inlet passage 111 is allowed to enter the cylinder 21 via the gap between the cylinder and the main body 11, so as to drive movement of the piston 22 and the striking member 23 to perform the nail-striking action (i.e., to strike the nail in the muzzle 12).

When the driving process is completed, a recoil of the nail gun will cause the moving assembly 400 (i.e., the assembly of the safety member 41 and the extending member 42) to bounce briefly away from the first switch 31, which further causes the operating member 52 to become separated from the moving path of the moving assembly 400 (see FIG. 6). At this time, the subsequent driving process is prohibited. That is, the driving process and the nail-striking action can only be re-executed when the trigger 51 and the safety member 41 are both released, thus preventing safety hazards.

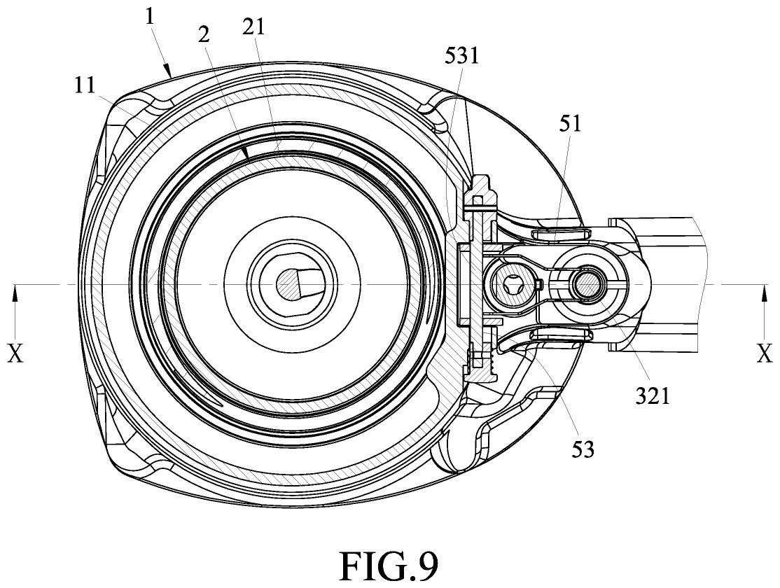

Referring to FIGS. 7 and 8, when the switching member 53 is rotated such that the eccentric shaft 531 is moved slightly away from the first switch 31 along the moving direction (Y) (see FIG. 9) to pivot the trigger 51 to the continuous firing position, the trigger unit 5 as a whole is moved slightly toward the cylinder 21 (see FIGS. 3 and 9). As a result, when the trigger 51 is first pressed to move the pivot end 521 of the operating member 52 toward the second switch 32, the distal end 522 of the operating member 52 remains in the moving path of the moving assembly 400. Next, when the workpiece-engaging end 412 of the safety member 41 is pressed by the workpiece such that is safety unit 4 is converted to the triggerable state, the first switch 31 and the second switch 32 are actuated by the extending member 42 and the pressing portion 523 of the operating member 52, respectively, to initiate the driving process. When the driving process is completed, as long as the trigger 51 is not released, the first switch 31 and the second switch 32 may be easily re-actuated by pressing the workpiece-engaging end 412 of the safety member 41 against the workpiece again, and the driving process may be repeated as many times as needed.

It should be noted that, when the trigger 51 is at the continuous firing position, the distal end 522 of the operating member 52 is always in the moving path of the moving assembly 400 even when the moving assembly 400 is bouncing away from the first switch 31 during the recoil of the nail gun. Therefore, as long as the safety member 41 is pressed by the workpiece and the trigger 51 is pulled, the driving process will always be initiated to perform the nail-striking action.

In sum, the present embodiment of the nail gun has benefits as follows.

By virtue of the first switch 31 and the second switch 32, the present embodiment of the nail gun is able to ensure the safety of a user as well as complying with industrial regulations. Further, by virtue of the configurations of the switching member 53 and the trigger 51, the present embodiment can be easily switched between sequential firing mode and continuous firing modes as desired, providing the user with a more flexible and convenient option compared with the prior art.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A nail gun comprising:
a frame unit;
a power unit that is mounted to said frame unit, and that is configured to drive a nail-striking action during a driving process;
a switch unit that is mounted to said frame unit, and that includes a first switch and a second switch configured to initiate the driving process when both actuated;
a safety unit that is operable to convert between a non-triggerable state where said safety unit is distal from said first switch, and a triggerable state where said safety unit actuates said first switch, said safety unit including a moving assembly that is movable relative to said frame unit along a moving path; and
a trigger unit that includes
a trigger pivotally mounted to said frame unit, and being pivotable between a sequential firing position and a continuous firing position, and
an operating member pivotable between said trigger and said second switch;
wherein when said safety unit is in the triggerable state, and when said trigger is pivoted from the sequential firing position toward said second switch, said operating member is moved by said trigger to contact said safety unit, to thereby actuate said second switch to initiate the driving process, after which said operating member separates from the moving path of said moving assembly of said safety unit so as to prevent initiation of subsequent driving process;
wherein when said trigger unit is pivoted from the continuous firing position toward said second switch, and when said safety unit is converted from the non-triggerable state into the triggerable state, said moving assembly of said safety unit comes into contact with said operating member to initiate the driving process.

2. The nail gun as claimed in claim 1, wherein said trigger unit further includes a switching member that rotatably extends through said frame unit, that has an eccentric shaft extending rotatably into said trigger, that is rotatable to move said eccentric shaft toward said first switch along a moving direction so as to pivot said trigger to the sequential firing position, and that is rotatable to move said eccentric shaft away from said first switch along the moving direction so as to pivot said trigger to the continuous firing position.

3. The nail gun as claimed in claim 2, wherein said first switch and said second switch are arranged along the moving direction.

4. The nail gun as claimed in claim 1, wherein said safety unit includes a safety member that extends along a length direction, and that is movably mounted to said frame unit, and that has an abutting end proximate to said switch unit, and a workpiece-engaging end opposite to said abutting end and adapted to be pressed by a workpiece, and an extending member that abuts against and is disposed between said safety member and said first switch and that cooperates with said safety member to constitute said moving assembly of said safety unit.

5. The nail gun as claimed in claim 4, wherein said safety unit further includes:
a sleeve member that is connected to said frame unit, that extends along the length direction, and that has two open ends being opposite along the length direction, said first switch and said extending member extending into said open ends of said sleeve member, respectively;
a safety member-biasing resilient member that is disposed between said frame unit and said safety member for biasing said workpiece-engaging end of said safety member away from said frame unit; and
an extending member-biasing resilient member that is disposed between said sleeve member and said extending member for biasing said extending member away from said first switch.

6. The nail gun as claimed in claim 5, wherein said operating member has a pivot end that is pivoted to said trigger, and a distal end that is opposite to said pivot end, that extends into the moving path of said moving assembly of said safety unit when said trigger unit is at the continuous firing position, and that is spaced apart from the moving path of said moving assembly of said safety unit when said trigger unit is at the sequential firing position.

7. The nail gun as claimed in claim 6, wherein said operating member further has a pressing portion that is connected between said pivot end and said distal end and that is configured for pressing against and actuating said second switch.

8. The nail gun as claimed in claim 1, wherein said power unit includes a cylinder adapted for receiving a pressurized gas, a piston movably disposed in the cylinder and adapted to be driven by the pressurized gas, and a striking member co-movably connected to said piston and configured to perform the nail-striking action, said switch unit being adapted to control the pressurized gas to be input into said cylinder.

9. The nail gun as claimed in claim 8, wherein:
said frame unit has an inlet passage adapted for guiding the pressurized gas into said cylinder, a switch passage adapted for guiding gas to drive movement of said cylinder relative to said frame unit so as to allow the pressurized gas to enter said cylinder through the inlet passage, a first valve room in fluid communication with said switch passage, a second valve room in fluid communication with said inlet passage, and a connecting passage disposed between and in fluid communication with said first valve room and said second valve room;
said first switch is installed in said first valve room, and has a first valve rod that openably blocks the fluid communication between said first valve room and said switch passage, said safety unit being configured to press against said first valve rod so as to open the fluid communication between said first valve room and said switch passage; and
said second switch is installed in said second valve room, and has a second valve rod that openably blocks the fluid communication between said second valve room and said connecting passage, said operating member being configured to press against said second valve rod so as to open the fluid communication between said second valve room and said connecting passage.

10. The nail gun as claimed in claim 8, wherein:
said frame unit includes a main body that has said inlet passage, said switch passage, said first valve room, said second valve room and said connecting passage, said first valve room having a first neck section, said second valve room having a second neck section;
said first switch further has a valve rod-biasing resilient member disposed between said main body and said first valve rod for biasing said first valve rod to movably blocks said first neck section of said first valve room; and
said second switch further has a valve member movably disposed in said second valve room, adapted to be forced by pressurized gas to block said second neck section of said second valve room, and configured to be pushed by said second valve rod to unblock said second neck section.
